(19) United States
(12) Patent Application Publication
(10) Pub. No.: US 2012/0239497 A1
(43) Pub. Date: Sep. 20, 2012

(54) METHOD AND PROCESS OF USING A SOCIAL NETWORK TO RETARGET A PERSONAL ADVERTISEMENT

(75) Inventor: Frank Anthony Nuzzi, Pflugerville, TX (US)

(73) Assignee: eBay Inc., San Jose, CA (US)

(21) Appl. No.: 13/050,827

(22) Filed: Mar. 17, 2011

(51) Int. Cl. G06F 17/30; G06Q 30/00

(52) U.S. Cl. 705/14.53; 707/709; 707/E17.108

(57) ABSTRACT

In various exemplary embodiments, a system, a method, and a related non-transitory computer-readable storage medium, of targeting advertisements based on a lifestyle change for an individual is disclosed. The method includes scanning a plurality of social sites to determine the lifestyle change and making a determination whether one or more keywords related to the lifestyle change are found in at least one of the plurality of social sites. Based on the determination that the one or more keywords are found in at least one of the plurality of social sites, the method continues with querying an end-user of the at least one of the plurality of social sites, determining an event related to the lifestyle change, matching an advertisement targeted to the event, and electronically sending the targeted advertisement to either the end-user or the individual.

### TECHNICAL FIELD

The present application relates generally to the field of computer technology and, in a specific exemplary embodiment, to a system and method of determining targeted personalized ads to individuals in social networks.

### BACKGROUND

Advertisements are becoming increasingly targeted to likes, dislikes, and influences of particular individuals. As such, advertisements are becoming more specific and targeted to individuals based upon some set of preferences. For example, if you watch a streaming video of a movie on Hulu™ (Hulu is based in Los Angeles, Calif.), the Hulu™ service will ask the end-user of the service whether or not the advertisement is relevant. At that point in time, the end-user makes a binary decision (yes or no) and lets the advertisement service know the preference of the end-user. Internet-based advertisement services can function similarly. For example, advertisements will be displayed based on what is being shown on a given webpage or even past webpage navigation; the tacit assumption being that the advertisement must be relevant and of interest or the end-user would not be surfing to this particular page. The problem with these types of targeted advertisements is that advertisers assume that the end-user's tastes and preferences are fixed and invariable over time. For example, the end-user's tastes may change over time or as a result of moving into a different stage of life. For example, a young couple could move from dating to marriage to having children. Each of these lifestyle changes would likely bring different preferences in advertisement. Traditionally, advertisers could randomly display ads to test whether or not the user is in a life stage transition but in the end, such haphazardly-placed targeted advertisements are merely a guess.

### BRIEF DESCRIPTION OF DRAWINGS

Various ones of the appended drawings merely illustrate exemplary embodiments of the inventive subject matter presented herein. Therefore, the appended drawings cannot be considered as limiting a scope of the inventive subject matter.

FIG. 1 shows a simplified high-level diagram depicting an environment, according to various exemplary embodiments, for determining preferences of a social group;

FIG. 2 is a block diagram illustrating an exemplary embodiment of a high-level client-server-based network architecture diagram depicting a system used to determine preferences, assemble related advertisements, and search for available inventory;

FIG. 3 is a block diagram illustrating an exemplary embodiment of various modules of the network architecture of FIG. 2;

FIG. 4 is a block diagram illustrating interactions between a hosted service and conventional search engines in accordance with various embodiments discussed herein;

FIG. 5 is a flowchart indicating a method of searching for lifestyle changes in accordance with various exemplary embodiments of the inventive subject matter;

FIG. 6 is an illustrative drawing of an advertisement selection system usable in conjunction with the information gathering system of FIG. 4; and

FIG. 7 is a simplified block diagram of a machine in an exemplary form of a computing system within which a set of instructions, for causing the machine to perform any one or more of the methodologies discussed herein, may be executed.

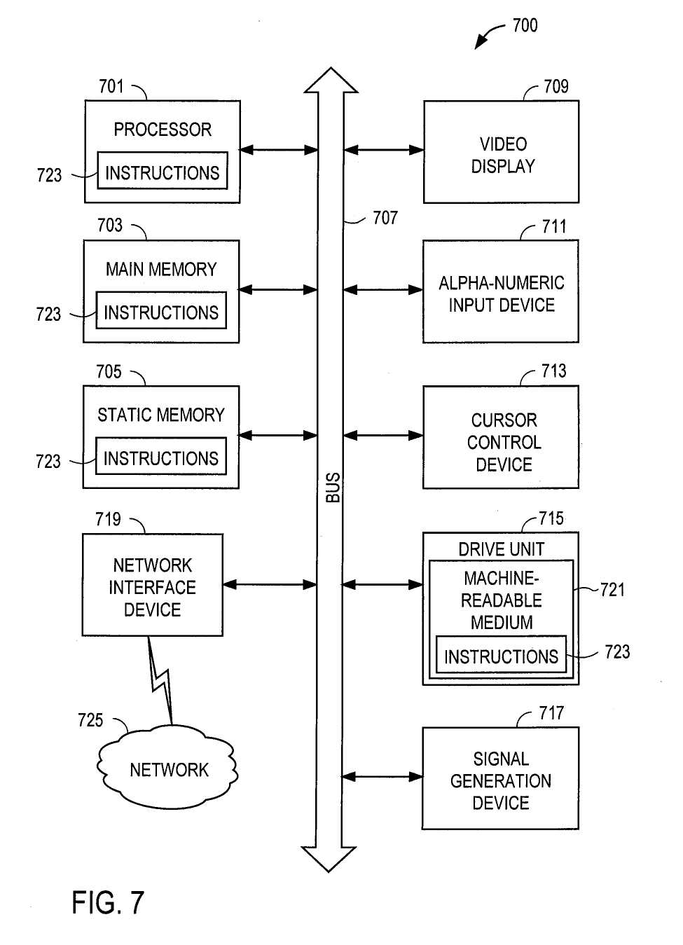

### DETAILED DESCRIPTION

The description that follows includes illustrative systems, methods, techniques, instruction sequences, and computing machine program products that embody various aspects of the inventive subject matter described herein. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on collecting information (e.g., such as metadata related to an end-user) and targeting advertisements based on the collected information, the embodiments are given merely for clarity in disclosure. Thus, any type of electronic commerce or electronic business system and method, including various system architectures, may employ various embodiments of the systems and methods of collecting information and using metadata associated with the collected information to generate a set of collective preferences and advertisements directed thereto, as described herein, and are considered as being within a scope of the inventive subject matter described.

The inventive subject matter described herein relates to targeted advertisements. For example, various embodiments of the inventive subject matter discussed herein describe using friends and family in a social network to retarget advertisements. In a specific exemplary embodiment, an advertisement service would display an advertisement specifically about a friend of the end-user. The advertisement would ask a question like, “Is one of your friends having a baby?” If the person reacts to the advertisement and answers a query presented by the service, the service could then use the preference and, using various forms of social networking (referred to also as conversations) to make an intelligent guess and narrow down which friends it could be. For example, the service would exclude any male friends. Also, it could further narrow by age, say only look for females 20 to 40 years of age. Once the demographics and choices have been narrowed down, the service could submit a follow up targeted advertisement such as, “Send your friend a 20% coupon at Babies ‘R’ Us.”

Also, the service could intelligently make an assessment about life stage changes by the sites an end-user is visiting. For example, the service can make a determination of the age of the end-user (as described herein). Knowing the age of the end-user, say a 49-year-old female, and logging web sites visited, such as baby sites, the service can make a reasonable assumption that it is not the end-user that is having a baby but rather someone close to the end-user (e.g., perhaps a daughter or daughter-in-law). The service could search the end-user's social network and display advertisements to the people in the social network that match the criteria (the criteria being a female relative of birthing age).

Given the above two simplified examples, discussed above, the service could then start to target friends and family members who may be in the transition of life stages. Thus, the service could narrow down the targeted advertisements to a specific set of people who most likely are in a life stage change. If one of the targeted people reacts to the advertisements, the service could begin to change the preferences of the advertisement and make a link between the third-party user and the person of the life stage. Additionally, the service could view the third-party user and see additional events that could be happening in the life stages of various people.

As noted in the various embodiments described herein, even if a particular person undergoing the life style change is not active in, for example, social networking, the inventive subject matter can nonetheless be used to target advertisements appropriately nonetheless. There may be reasons why the particular person could be active on the Internet but not actively displaying life-changing status. However, a friend or relative may be more active in posting the status of the particular person.

In a specific exemplary embodiment, assume that Erin's Aunt Jane is an active Facebook® (Facebook, Inc. is based in Palo Alto, Calif.) user. Aunt Jane loves to display the status of what is important in her life including events in her family's life. Erin is an active user on the Internet and is also on Facebook®. However, Erin infrequently updates Facebook® status. Erin finds out she is having a baby and tells her Aunt Jane but Erin does not want anyone to know. Aunt Jane immediately posts a status update that “someone she knows” is having a baby. The service picks up on Aunt Jane's post and displays an advertisement relevant to her post. The service narrows down the likely people in Aunt Jane's social network and displays an advertisement to Erin while she is surfing the Internet.

In an exemplary embodiment, a method, and a related non-transitory computer-readable storage medium, of targeting advertisements based on a lifestyle change for an individual is disclosed. The method includes scanning a plurality of social sites to determine the lifestyle change and making a determination whether one or more keywords related to the lifestyle change are found in at least one of the plurality of social sites. Based on the determination that the one or more keywords are found in at least one of the plurality of social sites, the method continues with querying an end-user of the at least one of the plurality of social sites, determining an event related to the lifestyle change, matching an advertisement targeted to the event, and electronically sending a targeted advertisement to either the end-user or the individual.

In another exemplary embodiment, a system to target advertisements based on a lifestyle change for an individual is disclosed. The system includes a server, having one or more processors, to scan conversations on a plurality of social sites to determine the lifestyle change and an event database to store and analyze at least portions of the conversations related to the lifestyle change. The event database is further arranged to determine an event related to the lifestyle change. An advertisement database is arranged to match an advertisement targeted to the event and an advertisement server electronically sends a targeted advertisement to either the end-user or the individual. Each of these exemplary embodiments, and others, is discussed in detail, below.

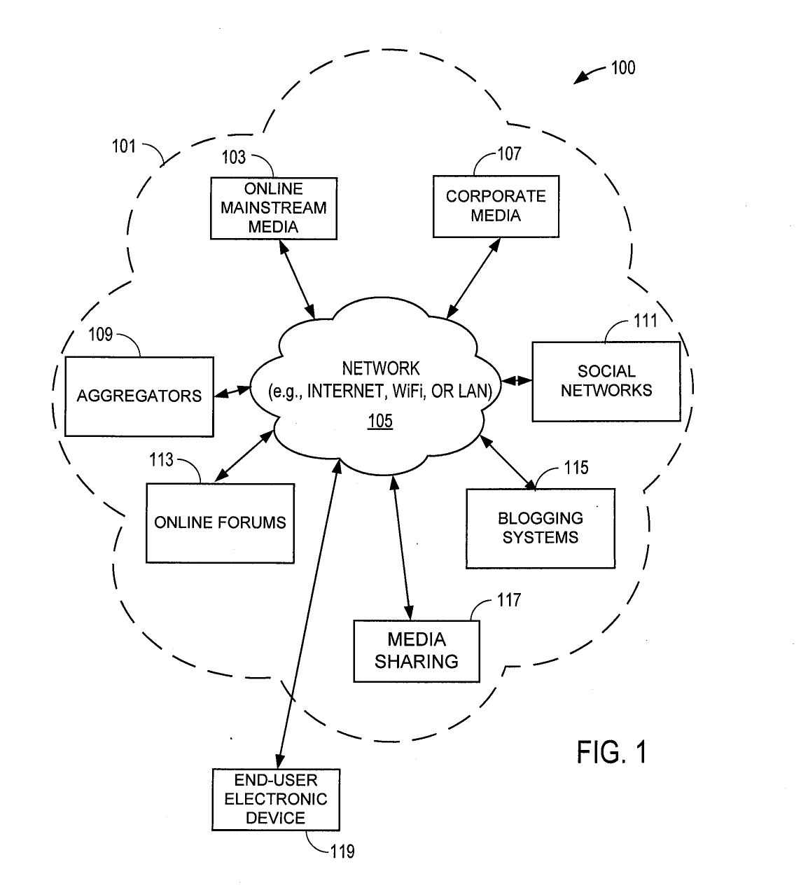

With reference now to FIG. 1, a simplified version of a high-level diagram 100 depicting an environment according to various exemplary embodiments of gathering metadata from patrons is shown. The high-level diagram 100 is shown to include a social media network 101, online mainstream media 103, corporate media 107, other social networks 111, blogging systems 115, media sharing sites 117, online forums 113, and various aggregators 109. Each of these elements is communicatively coupled to one another through a network 105 (e.g., the Internet, a Wi-Fi, or a WLAN). An end-user electronic device 119 of a patron or end-user can access the various elements within the social media network 101 through the network 105.

In a specific example, the high-level diagram 100 illustrates how a conversation can flow within the social media network 101 and interact with the online mainstream media 103 and the corporate media 107. In the social media network 101, links between various publishers within the social media network 101 permit the publishers to post Web content, provide comments, and post links. Consequently, a conversation about a topic can flow and be amplified through the social media network 101 and also interact with the online mainstream media 103 and the corporate media 107. For example, the online mainstream media 103 can vouch for the veracity of a posted news report. The corporate media 107 can interact with various publishers and can provide product support information through the media sharing sites 117. Also, the various aggregators 109 may capture and store various blogs and postings in an archive. Thus, some aspects of trust relationships can be observed such as publishers making comments supporting the veracity of the postings of others, publishers making comments to correct errors, and publishers providing links to other publishers within the social media network 101. Consequently, there is a tremendous amount of information obtainable from the social networks.

One of the publishers on the social media network 101 may be an individual utilizing the end-user electronic device 119. The end-user electronic device 119 may be, for example, a personal computer, a laptop, a notebook, a smart phone, or other electronic device capable of accessing the network 105 and posting and retrieving information from the social media network 101.

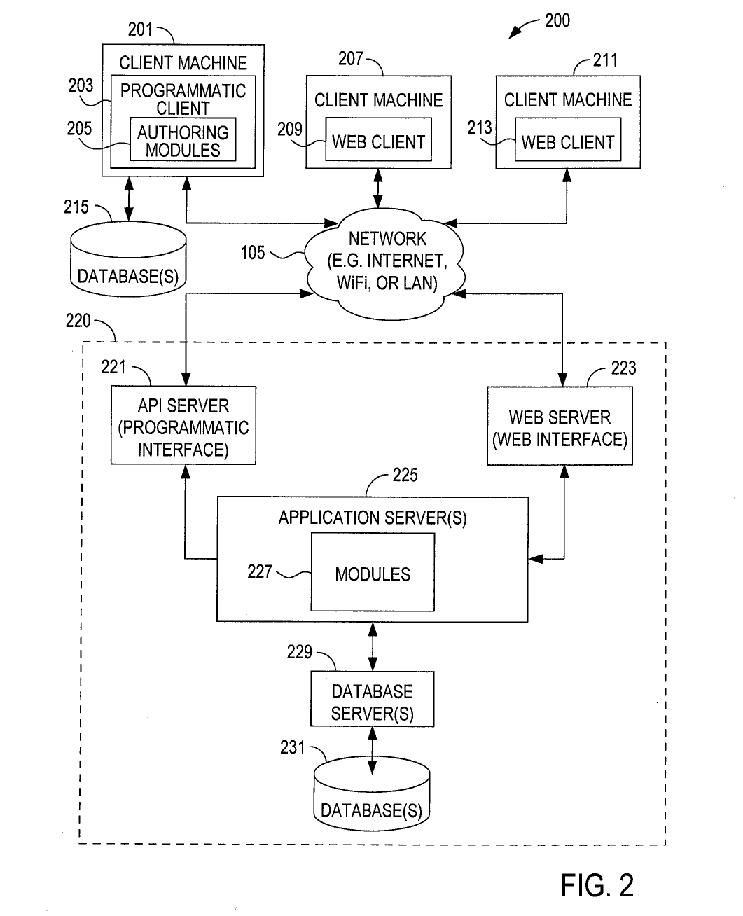

With reference to FIG. 2, a high-level network diagram of an exemplary embodiment of a system 200 with a client-server architecture includes a first client machine 201, a second client machine 207, a third client machine 211, a network 105 (e.g., the Internet), and an information storage and retrieval platform 220. Each of the client machines 201, 207, 211 can be considered as the end-user electronic device 119, as described above. In this embodiment, the information storage and retrieval platform 220 constitutes a commerce platform or commerce server and provides server-side functionality, via the network 105, to the first 201, second 207, and third 211 client machines. A programmatic client 203 in the form of authoring modules 205 executes on the first client machine 201. A first web client 209 (e.g., a browser, such as the Internet Explorer® browser developed by Microsoft® Corporation of Redmond, Wash.) executes on the second client machine 207. A second web client 213 executes on the third client machine 211. Additionally, the first client machine 201 is coupled to one or more databases 215.

Turning to the information storage and retrieval platform 220, an application program interface (API) server 221 and a web server 223 are coupled to, and provide programmatic and web interfaces respectively to, one or more application servers 225. The application servers 225 host one or more modules 227 (e.g., modules, applications, engines, etc.). The application servers 225 are, in turn, coupled to one or more database servers 229 facilitating access to one or more information storage databases 231. The one or more modules 227 provide a number of information storage and retrieval functions and services to users accessing the information storage and retrieval platform 220. The one or more modules 227 are discussed in more detail, below.

While the system 200 of FIG. 2 employs a client-server architecture, a skilled artisan will recognize that the present disclosure is not limited to such an architecture. The system 200 could equally well find application in, for example, a distributed, or peer-to-peer, architecture system. The one or more modules 227 and the authoring modules 205 may also be implemented as standalone software programs, which do not necessarily have networking capabilities.

The first 209 and second 213 web clients access the one or more modules 227 via the web interface supported by the web server 223. Similarly, the programmatic client 203 accesses the various services and functions provided by the one or more modules 227 via the programmatic interface provided by the API server 221. The programmatic client 203 is, for example, a seller application (e.g., the “Turbo Lister 2” application developed by eBay® Inc., of San Jose, Calif.) enabling sellers to author and manage data items or listings on the information storage and retrieval platform 220 in an off-line manner. Further, batch-mode communications can be performed between the programmatic client 203 and the information storage and retrieval platform 220. In addition, the programmatic client 203 can include, as previously indicated, the authoring modules 205 used to author, generate, analyze, and publish domain rules and aspect rules. The domain and aspect rules are used in the information storage and retrieval platform 220 to structure the data items and transform queries. Such domain and aspect rules are known independently in the art.

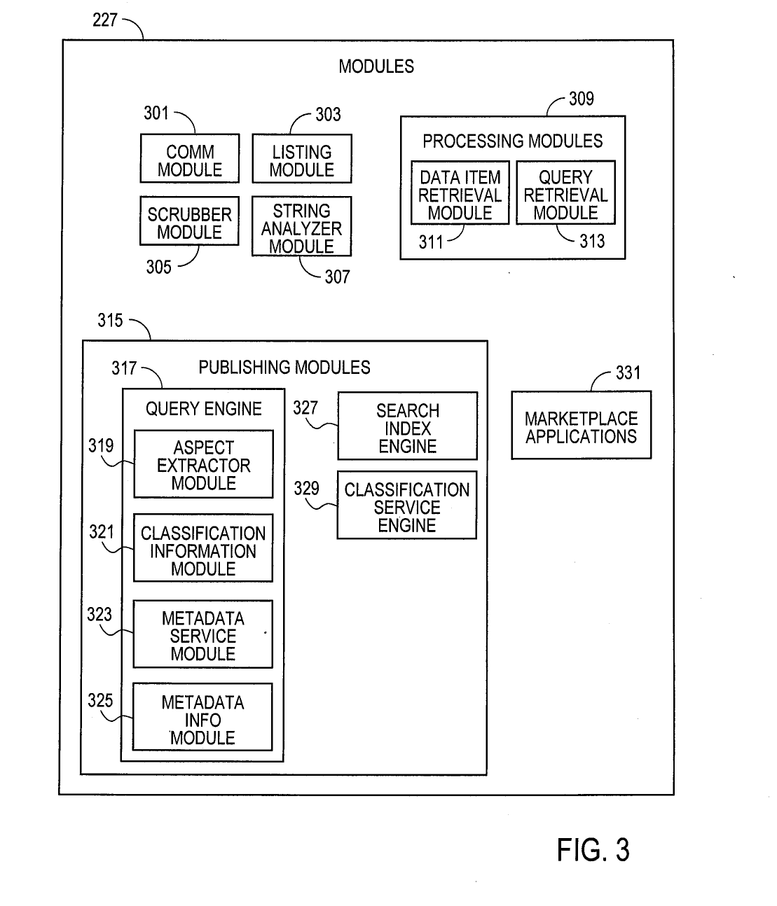

Referring now to FIG. 3, an exemplary block diagram of the one or more modules 227 of FIG. 3 includes a communication module 301, a listing module 303, a scrubber module 305, a string analyzer module 307, a plurality of processing modules 309, and publishing modules 315. The one or modules 227 further includes a marketplace application block 331. Each of these various modules can assist in the storage and searching of metadata for various ones of the selected items from the digital event, discussed above.

The communication module 301 receives a query from one or more of the client machines 201, 207, 211 (see FIG. 2). The query includes one or more constraints (e.g., keywords, categories, or information specific to a type of data item). The communication module 301 interacts with a query engine 317 and a search index engine 327, both located in the publishing modules 315, to process the query. In conjunction with the query engine 317 and the search index engine 327, the communication module 301 attempts to extract aspect-value pairs (e.g., brand=“Donna Karan”) based on the query. Details of the aspect-value pairs are described in more detail, below.

The publishing modules 315 publish new or existing rules, as discussed above with reference to FIG. 2, to the information storage and retrieval platform 220, thereby enabling the rules to be operative (e.g., applying the rules to data items and queries). In a specific exemplary embodiment, the information storage and retrieval platform 220 of FIG. 2 may be embodied as a network-based marketplace that supports transactions of data items or listings (e.g., goods or services) between sellers and buyers. One such marketplace is eBay®, The World's Online Marketplace®, developed by eBay® Inc., of San Jose, Calif. In this embodiment, the information storage and retrieval platform 220 receives information from sellers describing the data items. The data items are subsequently retrieved by potential buyers or bidders. The one or more modules 227 include the marketplace application block 331 to provide a number of marketplace functions and services to end-users accessing the information storage and retrieval platform 220.

The publishing modules 315 further include a classification service engine 329. The classification service engine 329 applies domain rules to identify one or more domain-value pairs (e.g., product type=women's blouses) associated with the data item. The classification service engine 329 further applies the aspect rules to identify aspect-value pairs associated with the data item. The classification service engine 329 applies the domain and aspect rules to data items or listings as they are added to the information storage and retrieval platform 220 or responsive to the publication of new rules (e.g., domain rules or aspect rules). The scrubber module 305 utilizes services of the classification service engine 329 to structure the item information in the data item (e.g., the classification service engine 329 applies domain and aspect rules). The classification service engine 329 then pushes or publishes item search information over a bus (not shown but implicitly understood by a skilled artisan) in real time to the search index engine 327.

The search index engine 327 includes search indexes and data item search information (e.g., including data items and associated domain-value pairs and aspect-value pairs). The search index engine 327 receives the transformed query from the communication module 301 and utilizes the search indexes to identify data items based on the transformed query. The search index engine 327 communicates the found data items to the communication module 301.

A query retrieval module 313, within the plurality of processing modules 309, receives information from one or more of the client machines 201, 207, 211 and stores the information as a data item in the one or more information storage databases 231 (see FIG. 2). For example, an end-user, acting as a seller and operating on one of the client machines, enters descriptive information for the data item to be offered for sale or auction through the information storage and retrieval platform 220.

The plurality of processing modules 309 receives classification information and metadata information associated with the data item. The information is published to, for example, a local backend server (not shown) hosting the query engine 317, the search index engine 327, and the classification service engine 329.

The plurality of processing modules 309 further includes a data item retrieval module 311 to receive requests for data items from a client machine. For example, responsive to receiving a request, the data item retrieval module 311 reads data items from the data item information stored on the one or more information storage databases 231 (FIG. 2) and stores the data items as sample information in the one or more databases 215 for access by the client machine. Responsive to receiving the request, the query retrieval module 313 reads queries from the sample information and communicates the queries to the client machine.

The string analyzer module 307 receives requests from the first client machine 201 to identify candidate values to associate with an aspect. The request may include the aspect and one or more values that have been associated with the aspect. The string analyzer module 307 utilizes the aspect (e.g., “color”) to identify strings of text in a database that includes the aspect. The string analyzer module 307 relies on various services provided in the information storage and retrieval platform 220 to identify and process the strings of text. For example, the string analyzer module 307 utilizes services that expand the aspect to a derivative form of the aspect including a singular form (e.g., “color”), a plural form (e.g., “colors”), a synonymous form, an alternate word form (e.g., “chroma,” “coloring,” or “tint”), a commonly misspelled form (e.g., “collor”), or an acronym form.

A database (not shown specifically) used by the string analyzer module 307 includes queries or data items that have been entered by an end-user (e.g., buyer or seller, respectively, although a seller may wish to enter queries as well) to the information storage and retrieval platform 220. The database can also store or reference dictionaries, thesauruses, or other reference sources. The string analyzer module 307 analyzes the strings of text to identify candidate values to associate with the aspect. More examples of query strings and searching techniques are given, below.

The query engine 317 includes an aspect extractor module 319, a classification information module 321, a metadata service module 323, and a metadata information module 325. The aspect extractor module 319 receives a query from the communication module 301 and applies aspect rules to extract aspect-value pairs from the query. Further, the aspect extractor module 319 communicates the query received from the communication module 301 to the plurality of processing modules 309 that stores the query as sample query information.

The classification information module 321 includes phrases from a plurality of past searches to reference against the query. For example, synonyms or related information for a query can be stored in the classification information module 321 to aid an end-user in locating an item or a particular set of items.

The metadata service module 323 communicates descriptive metadata information to the communication module 301 based on a query received from the communication module 301. The metadata information is retrieved from the metadata information module 325 and includes metadata that the communication module 301 uses to format and generate an end-user interface to provide additional information to the end-user based on the original end-user-generated query.

Once aspect-value pairs, classification information, and other relevant information is retrieved through, for example, either the data item retrieval module 311 or the query retrieval module 313, the listing module 303 provides additional assistance to an end-user listing the data item. The additional assistance can be, for example, one or more interfaces for the end-user to upload photographs, textual descriptions, and bidding information.

Although the one or more modules have been defined in terms of a variety of individual modules and engines, a skilled artisan will recognize that many of the items can be combined or organized in other ways. The description given herein simply provides an exemplary embodiment to aid the reader in an understanding of the systems and methods used herein.

Various embodiments of the inventive subject matter may be implemented in different ways, such as within an enterprise computing environment (e.g., the high-level client-server-based network architecture of FIG. 2) or as a computer-readable medium (discussed in more detail, below). However, in an exemplary embodiment, the inventive subject matter can be based on information collected and analyzed in a hosted service.

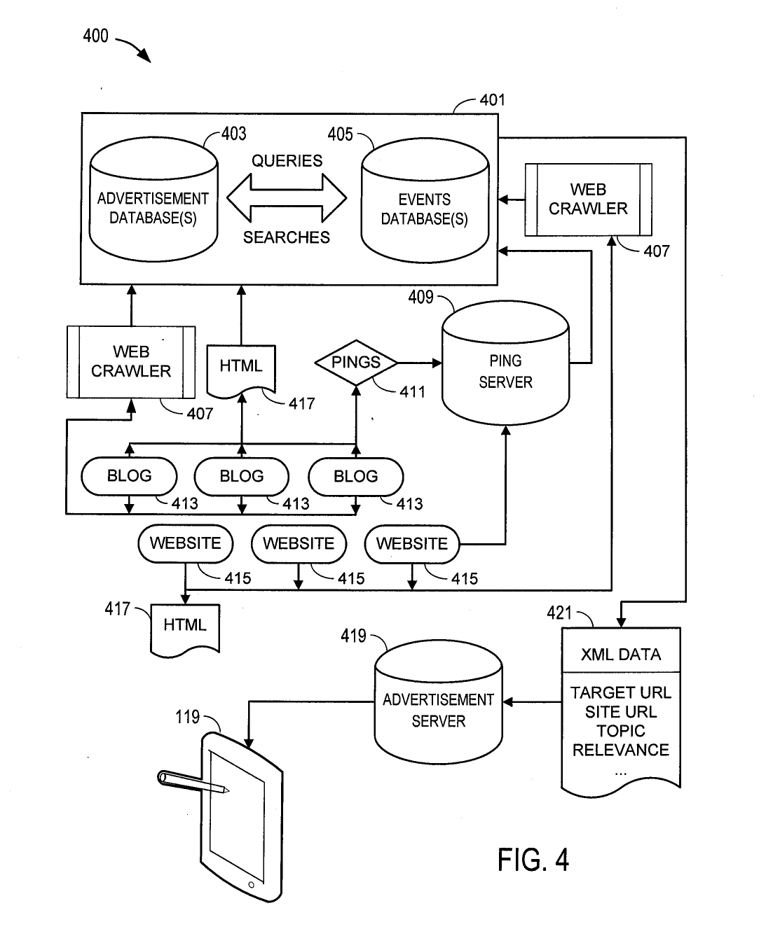

For example, with reference to FIG. 4, an embodiment of the inventive subject matter is shown as a hosted service environment 400. In various embodiments, the hosted service environment 400 can be used to monitor, search, and review a variety of “conversations.” Conversations, in this context, can describe various on-line postings, chats, tweets, and other publically-displayed information. As discussed above, an aspect of social media is that it is highly conversational in nature. Consequently, social media is available on a huge variety of topics, and, due to the tremendous amount of publically-available information, the social media can be logged and analyzed. The hosted service environment 400 can be used to monitor, for example, full-text linking of relationships of the social media network 101 (FIG. 1). In monitoring the various conversations, the hosted service environment 400 can categorize, store, and index to support later analysis of the networked conversations. As discussed, input criteria (e.g., keywords and URLs) may be input by an end-user to define a topic of conversation. The hosted service environment 400 then monitors the conversation using various social analysis tools.

The hosted service environment 400 is shown to include a hosted server 401, a number of web crawlers 407, a ping server 409, a number of blogs 413, a number of websites 415, and an advertisement server 419. In various embodiments, the hosted server 401 can be used by numerous other companies, advertising firms, and others to provide services for crawling the web and blogs looking for particular search terms or keywords. In other embodiments, the hosted server 401 can be dedicated to a single company or advertising firm to fulfill their own internal advertising needs.

The hosted server 401 is shown to include an advertisement database 403 and an events database 405. The advertisement database 403 stores a variety of various advertisements that may be of interest to end-user involves in social media. The events database 405 stores a variety of event types such as, for example, birthdays, anniversaries, baby showers, and so on to correlate with various advertisements in the advertisement database 403.

In various embodiments, the events database 405 can correlate keywords matched to events found in social media sites with appropriate event scenarios. For example, an event found relating to a couple's seventh wedding anniversary can search the events database 405 and find that traditional seventh wedding anniversary gifts include materials comprising copper and wool and that modern gifts include materials comprising brass. The events database 405 can then correlate with the advertisement database 403 to find appropriate advertisements. In various embodiments, the events database 405 may also store profiles of people participating in the conversations such as particular relevant dates for a particular person or group of people. For example, a person's birthday can be saved on the events database 405 and related advertisements can be sent at a predetermined time (e.g., a week in advance of the birthday) to friends of the person before the birthday occurs. Such dates can frequently be gleaned from social interactions occurring over the web and may be determined using the hosted service environment 400, as discussed in more detail, below.

In various embodiments, the hosted service environment 400 supports retrospective web crawling. For example, the hosted server 401 can use crawling tools of the various ones of the web crawlers 407 to collect sets of HTML data 417 from various ones of the websites 415 and the blogs 413. The HTML data 417 are analyzed to identify components of the various pages and collect and store relevant text and data. The data can include HTML tags indicating the role of information in a conversation. Also, social influence data can be stored in the events database 405.

In exemplary embodiments, the hosted server 401 can capture data from the blogs 413 using XML-RPC pings generated by blogs or collected at the ping server 409, such as pingomatic.com or weblogs.com. Each of these services, and others, updates various search engines depending upon contents of various blogs. When crawling a blog, the full HTML can be captured from the page, using tags to identify components of the page and differentiating between individual postings, comments, and trackbacks displayed on the page. Each part of the page can be important to understanding a specific part of a networked discussion. Pings may also be used to initiate a crawl of a page.

Thus, the hosted service environment 400 may be used for monitoring various types of conversations over the network 105 (see FIG. 1) and for compiling chronological histories of discussion and social relationships. These compiled chronological histories can be stored in the events database 405 to form various profiles as discussed, above. The hosted service environment 400 utilizes the web crawlers 407 and the ping server 409 to extract content, hyperlinks, and perform additional analysis, such as analyzing scripts, forms, and layout tags to identify data created, the type of data, and various social links from, for example, the blogs 413 and the websites 415. In various embodiments, content of individual sites and blogs is examined. The content can be logged into the events database 405 for dates when information appeared and in what format the content was produced in (e.g., blog posting, news article, or comments about an article or blog posting). A navigable history of social exchanges within the data can then be constructed. Relationships between people and organizations that created the data are reconstructed revealing how ideas flowed between different sites, how the ideas were added to or amplified by individual participants, and what changes in perception were reflected in discussions of the target topic.

In various embodiments, the events database 405 can store and implement the previously described conversation monitoring and social analysis. As noted above, the events database 405 can have various functions. One function is to provide an XML feed 421 to an advertisement server 419 for advertisement placement on the delivery to the end-user electronic device 119. As illustrated in FIG. 4, in various embodiments, based on the various data collected, the events database 405 can generate the XML feed 421 that may be used by other applications or servers. The XML feed 421 may, for example, provide information to improve advertisement targeting, such as identifying key publishers and key times to insert an advertisement related to a particular event. The XML feed 421 may also, for example, identify a list of key influencers of a conversation, provide visualization of networked discussions, or other outputs. Additionally, the XML feed 421 may be used to create visualization, spreadsheets, or other information for an end-user (such as marketing personnel within a company or advertising firm) to understand a networked discussion. For example, the end-user may want a visualization or list identifying key influencers in a conversation, thresholds for the evolution of a conversation (e.g., key times in the development in a conversation), or a map illustrating the growth of a conversation.

In various embodiments, in addition to searching blogs and websites, the hosted server 401 can query third-party search engines (e.g., the advertisement server 419 or the databases 215 of FIG. 2) to assemble and analyze results for social relationships. The search results may be used to provide results annotated with the social data or to configure additional web crawling and data gathering for social analysis.

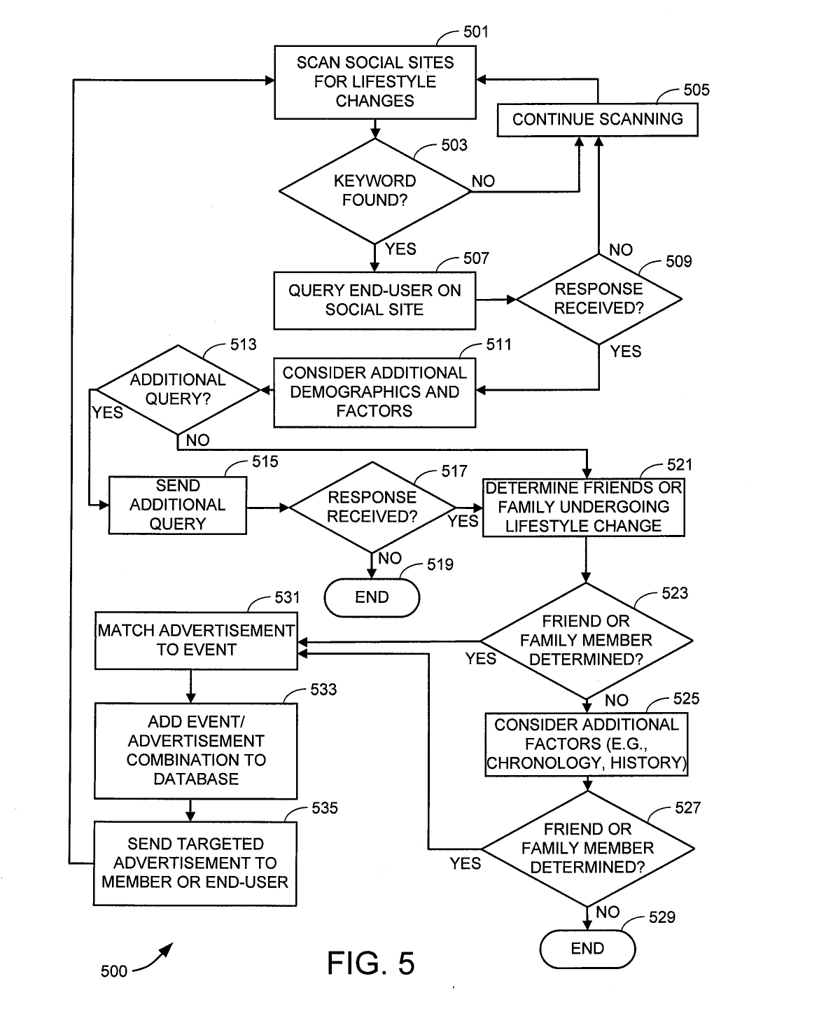

With reference now to FIG. 5, a flowchart indicating a method 500 of searching for lifestyle changes is shown. In various embodiments, the method 500 may be used in conjunction with the hosted service environment 400 of FIG. 4. Although the method 500 of FIG. 5 assumes a friend or family member of an end-user of one or more social sites is undergoing the lifestyle change, a skilled artisan will recognize that certain changes or additions may be made to the method 500 in the case the end-user himself or herself is undergoing the change. Also, the skilled artisan will recognize that certain modifications and additions to the method 500 may be made depending upon a given lifestyle event or based on various cultures. Thus, the exemplary embodiments shown in FIG. 5 are merely for clarity in disclosure and are not to be considered limiting.

At operation 501, the various websites, blogs, and other social networking sites are scanned for lifestyle changes. The lifestyle changes may be noted by scanning for particular keywords. At operation 503, a determination is made whether one or more particular keywords are found. If not, a determination is made at operation 505 simply to continue scanning. If one or more of the particular keywords is found, the end-user on the social site can be queried at operation 507. The query can include questions to elicit more information from the end-user such as “So you know someone who is having a baby—Congratulations! Would she like to receive free coupons for products for her new baby?”

At operation 509, a determination is made whether a response to the query is received (perhaps within a predetermined time frame such as within three days). If not, the method 500 simply continues scanning at operation 505. However, if a response is received, the method allows the hosted service environment 400 to consider additional demographics and other factors at operation 511. For example, based on the collected data, demographics and factors such as age range or location can be considered. Then, at operation 513, a determination is made whether a more targeted query should be presented. If a determination is made to present a more targeted query at operation 515, the query is sent. For example, the more targeted query may attempt to elicit more information such as, “Does your friend or family member live in California as well? If so, perhaps coupons from your local XYZ Corporation may be useful for her new baby!” A determination is made at operation 517 whether a response to the more targeted query has been received. If not, the method 500 may be terminated at operation 519 so as not to offend the end-user with too many queries.

However, if a response is received, or alternatively if a decision not to send an additional query was made at operation 513, the method 500 continues. At operation 521, a determination is made of exactly who the friend or family member is that is undergoing the lifestyle change (e.g., in the ongoing example, specifically who is having the baby and what is the identity of that individual). Data collected within the events database 405 can be searched and correlated for a determination of who the individual might be.

If, based on probabilistic or statistical determinations, a reasonable determination of the friend or family member can be made at operation 523, then an advertisement is selected to match the event at operation 531. The selection may be made based on data in the XML feed 421 being matched with an appropriate advertisement being available at the advertisement server 419 (see FIG. 4). For example, if a person is having a baby in California, then coupons from local or regional retailers of infant clothing can be selected. The selected advertisement is then added, at operation 533, as an event/advertisement combination at, for example, the advertisement server 419 or the events database 405 to assist in future advertisement matching choices. The targeted advertisement is then sent to the friend or family member at operation 535. The method 500 then continues at operation 501.

Alternatively, if at operation 523 the friend or family member cannot be determined, the method continues by considering additional factors at operation 525. The additional factors can include, for example, chronological data or other historical information collected and stored from the website or blog data.

Another determination is made, at operation 527, whether the friend or family member was determined. If so, the method 500 proceeds at operation 531 as discussed, above. If a determination is not made, the method may be terminated at operation 529.

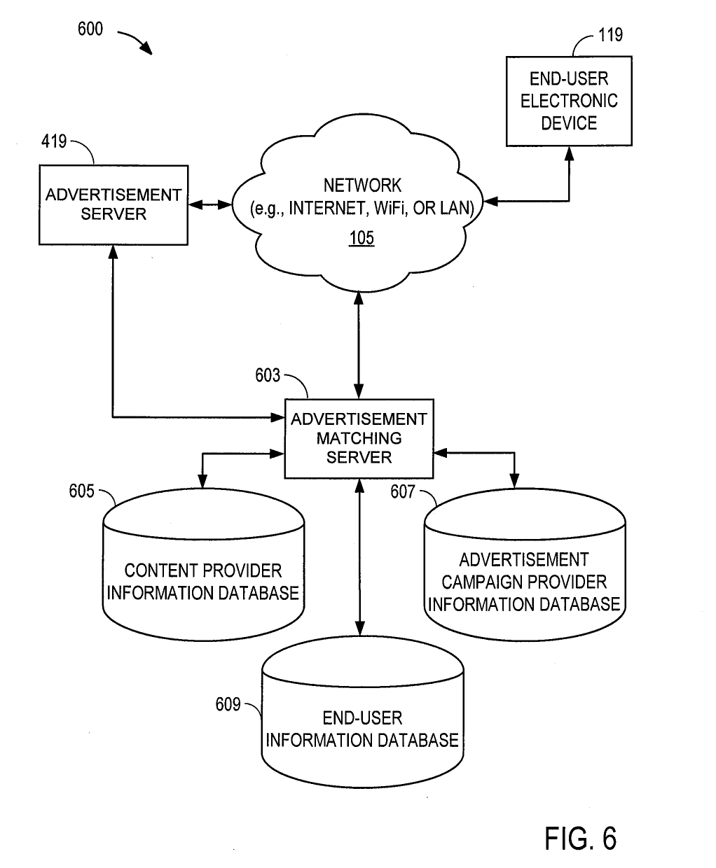

Referring now to FIG. 6, an exemplary illustrative drawing of an advertisement selection system 600 is shown to include an advertisement source server 601, an advertisement matching server 603, a content provider information database 605, an advertisement campaign provider information database 607, and an end-user information database 609. The content provider information database 605 stores content provider information. The advertisement campaign provider information database 607 stores advertisement campaign provider information. The advertisement campaign provider information database 607 includes an advertisement campaign storage region to store advertisement campaign provider content-related rules, a user-related rules storage region to store advertisement campaign provider user-related rules, and a campaign attributes storage region to store ad campaign attributes. Details concerning the content provider information database 605 and the advertisement campaign provider information database 607 are unimportant to the embodiments discussed herein. As is known independently in the art, there are a variety of ways in which such storage databases may be designed and implemented consistent with the various exemplary embodiments discussed. For example, storage databases may be implemented as a relational database. Content provider and advertisement campaign provider rules and attributes may be stored in the database as set of tables. In various embodiments, SQL statements may be used, for example, to calculate the matching.

As indicated above with reference to FIG. 3, in various embodiments, all or portions of the advertisement selection system 600 may be located within the information storage and retrieval platform 220 of FIG. 2. In various embodiments, all or portions of the advertisement selection system 600 may be located within an establishment (e.g., the various aggregators 109 of FIG. 1). Furthermore, the end-user information database 609 may be similar to the events database 405 of FIG. 4. In addition to advertisements provided by the various aggregators 109, other merchants or companies may also contribute to providing related advertisements for the end-user. Advertisements from these other merchants and companies can be stored in the advertisement campaign provider information database 607.

The advertisement source server 601 is arranged to select information for delivery to the end-user electronic device 119. The advertisement matching server 603 is communicatively coupled to the content provider information database 605, the advertisement campaign provider information database 607, and the end-user information database 609. The advertisement matching server 603 resolves content provider information, ad campaign provider information, generated end-user preferences, and other end-user information in order to determine an optimal matching of advertisements to content-user combinations in accordance with various embodiments of the inventive subject matter as described herein. The advertisement selection system 600 provides advertisement selection information to the advertisement source server 601 and indicates what advertisement information to transmit, through the network 105, to the end-user electronic device 119.

As noted, the advertisement matching server 603 may utilize various collected information from the social sites to determine advertisement related information to be delivered to the end-user electronic device 119. In an exemplary embodiment, the advertisement matching server 603 determines candidate advertisement related information based upon information stored in the content provider information database 605 (or the events database 405 of FIG. 4), the advertisement campaign provider information database 607, and the end-user information database 609. The advertisement matching server 603 determines which candidate advertisement related information to actually transmit to the end-user electronic device 119. The advertisement matching server 603 can provide an indication to the advertisement source server 601 as to what advertisement to select to transmit to the end-user electronic device 119. The advertisement source server 601 may then transmit the advertisement to the end-user electronic device 119 over the network 105.

A determination of what advertisements to deliver also may depend upon factors such as the amount that different advertisement campaign providers are willing to pay to have their advertisements delivered to an end-user having a particular profile, or to have their advertisements associated with particular content, or to have their advertisements matched to a particular end-user/preference combination. The amounts can be determined, for example, through a competitive bidding process.

Although the targeted advertisements may generally be considered to be for merchandise or items considered in terms of a tangible good, the merchandise or items can also be considered in terms of intangible goods or services. Examples of intangible goods can include information items (e.g., downloaded data or applications) and examples of services include human services (e.g., contracted work such as an offer for a pre-natal massage) and automated services (e.g., subscriptions to baby magazines). Other examples of products can include authorizations (e.g., access to services, licenses, or encryption keys for subscriber-only information). Thus, a skilled artisan will recognize that the merchandise or items in the targeted advertisements may be used to describe goods or services.

Additionally, various embodiments discussed herein may be combined, or elements selectively chosen to be adapted into a new embodiment. Thus, many more permutations are possible beyond those explicitly discussed. Therefore, while various embodiments of the inventive subject matter are described with reference to assorted implementations and exploitations, it will be understood that these embodiments are illustrative only and that a scope of the inventive subject matter is not limited merely to those described embodiments. Moreover, the systems and methods described herein may be implemented with facilities consistent with any hardware system or hardware systems either defined herein or known independently in the art using techniques described herein. Many variations, modifications, additions, and improvements are therefore possible based upon an understanding of the concepts and techniques expressed herein.

### Modules, Components, and Logic

Additionally, certain embodiments described herein may be implemented as logic or a number of modules, components, or mechanisms. A module, logic, component, or mechanism (collectively referred to as a “module”) may be a tangible unit capable of performing certain operations and is configured or arranged in a certain manner. In certain exemplary embodiments, one or more computer systems (e.g., a standalone, client, or server computer system) or one or more components of a computer system (e.g., a processor or one or more processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by cost and time considerations.

Accordingly, the term module should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Storage Medium

With reference to FIG. 9, an exemplary embodiment extends to a machine in the exemplary form of a computer system 900 within which instructions, for causing the machine to perform any one or more of the methodologies discussed herein, may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 900 includes a processor 901 (e.g., a central processing unit (CPU), a graphics processing unit (GPU) or both), a main memory 903 and a static memory 905, which communicate with each other via a bus 907. The computer system 900 may further include a video display unit 909 (e.g., a liquid crystal display (LCD) or a cathode ray tube (CRT)). The computer system 900 also includes an alphanumeric input device 911 (e.g., a keyboard), a user interface (UI) navigation device 913 (e.g., a mouse), a disk drive unit 915, a signal generation device 917 (e.g., a speaker), and a network interface device 919.

### Machine-Readable Medium

The disk drive unit 915 includes a non-transitory machine-readable medium 921 on which is stored one or more sets of instructions and data structures (e.g., software 923) embodying or used by any one or more of the methodologies or functions described herein. The software 923 may also reside, completely or at least partially, within the main memory 903 or within the processor 901 during execution thereof by the computer system 900; the main memory 903 and the processor 901 also constituting machine-readable media.

While the non-transitory machine-readable medium 921 is shown in an exemplary embodiment to be a single medium, the term “non-transitory machine-readable medium” may include a single medium or multiple media (e.g., a centralized or distributed database, or associated caches and servers) that store the one or more instructions. The term “non-transitory machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures used by or associated with such instructions. The term “non-transitory machine-readable medium” shall accordingly be taken to include, but not be limited to, solid-state memories, and optical and magnetic media. Specific examples of non-transitory machine-readable media include non-volatile memory, including by way of exemplary semiconductor memory devices (e.g., EPROM, EEPROM, and flash memory devices); magnetic disks such as internal hard disks and removable disks; magneto-optical disks; and CD-ROM and DVD-ROM disks.

### Transmission Medium

The software 923 may further be transmitted or received over a communications network 925 using a transmission medium via the network interface device 919 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of the inventive subject matter as represented by the appended claims. The specification and drawings are, accordingly, to be regarded in an illustrative rather than a restrictive sense.

What is claimed is:

1. A method of targeting advertisements based on a lifestyle change for an individual, the method comprising:
scanning, using one or more processors, a plurality of social sites to determine the lifestyle change;
making a determination whether one or more keywords related to the lifestyle change are found in at least one of the plurality of social sites; and
based on the determination that the one or more keywords are found in the at least one of the plurality of social sites
querying an end-user of the at least one of the plurality of social sites;
determining an event related to the lifestyle change;
matching an advertisement targeted to the event; and
electronically sending the targeted advertisement.

2. The method of claim 1, further comprising:
determining an identity of the individual undergoing the lifestyle change; and
electronically sending the targeted advertisement to the individual.

3. The method of claim 1, wherein the targeted advertisement is electronically sent to the end-user.

4. The method of claim 1, further comprising:
electronically collecting information from the plurality of social sites;
storing the collected information in an events database; and
analyzing the collected information for the event related to the lifestyle change.

5. The method of claim 4, further comprising searching HTML data from websites and blogs in the plurality of social sites utilizing web crawlers to collect the information.

6. The method of claim 4, wherein the collected information includes historical and chronological information.

7. The method of claim 6, further comprising analyzing the historical and chronological information to make a determination of an identity of the individual.

8. The method of claim 1, further comprising sending additional queries to the end-user to determine the individual undergoing the lifestyle change.

9. The method of claim 1, further comprising adding an event/advertisement combination to an events database once the advertisement has been matched to the event.

10. A system to target advertisements based on a lifestyle change for an individual, the system comprising:
a server, having one or more processors, to scan conversations on a plurality of social sites to determine the lifestyle change;
an event database to store and analyze at least portions of the conversations related to the lifestyle change, the event database further to determine an event related to the lifestyle change;
an advertisement database to match an advertisement targeted to the event; and
an advertisement server to electronically send the targeted advertisement.

11. The system of claim 10, wherein the event database is further to determine an identity of the individual undergoing the lifestyle change; and
the advertisement server is further to electronically send the targeted advertisement to the individual.

12. The system of claim 10, wherein the event database is further to search HTML data from websites and blogs in the plurality of social sites utilizing web crawlers to collect information.

13. The system of claim 12, wherein the collected information includes historical and chronological information.

14. The system of claim 13, wherein the event database is further to analyze the historical and chronological information to make a determination of an identity of the individual.

15. The system of claim 10, wherein the event database is further to send one or more queries to an end-user of at least one of the plurality of social sites to determine the individual undergoing the lifestyle change.

16. A non-transitory computer-readable storage medium storing instructions that, when executed by one or more processors, cause the one or more processors to perform an operation, the operation comprising:
scanning a plurality of social sites to determine a lifestyle change of an individual;
making a determination whether one or more keywords related to the lifestyle change are found in at least one of the plurality of social sites; and
based on the determination that the one or more keywords are found in the at least one of the plurality of social sites
querying an end-user of the at least one of the plurality of social sites;
determining an event related to the lifestyle change;
matching an advertisement targeted to the event; and
electronically sending the targeted advertisement.

17. The non-transitory computer-readable storage medium of claim 16, wherein the operation further comprises:
electronically collecting information from the plurality of social sites;
storing the collected information in an events database; and
analyzing the collected information for the event related to the lifestyle change.

18. The non-transitory computer-readable storage medium of claim 16, wherein the operation further comprises searching HTML data from websites and blogs in the plurality of social sites utilizing web crawlers to collect information.

19. The non-transitory computer-readable storage medium of claim 18, wherein the collected information includes historical and chronological information.

20. The non-transitory computer-readable storage medium of claim 19, wherein the operation further comprises analyzing the historical and chronological information to make a determination of an identity of the individual.
